(19) United States
(12) Patent Application Publication
(10) Pub. No.: US 2020/0085088 A1
(43) Pub. Date: Mar. 19, 2020

(54) CHOCOLATE PRODUCT WITH SOUR TASTE ATTRIBUTE AND PROCESS OF MAKING SUCH CHOCOLATE COMPOSITION

(71) Applicant: Purac Biochem B.V., Gorinchem (NL)

(72) Inventors: Adrianus Johannes Maria VAN LANKVELD, Veghel (NL); Christian Hendrik Andre Maria Van Kempen, Oss (NL)

(21) Appl. No.: 16/689,989

(22) Filed: Nov. 20, 2019

Related U.S. Application Data
(63) Continuation of application No. PCT/EP2018/063211, filed on May 18, 2018.

(30) Foreign Application Priority Data
May 22, 2017 (EP) 17172255.6

(51) Int. Cl. A23L 27/00; A23G 1/48

(52) U.S. Cl. CPC A23L 27/82; A23V 2002/00; A23L 27/72; A23G 1/48

(57) ABSTRACT

The present invention concerns chocolate compositions comprising components capable of imparting a sour taste attribute. The inclusion of a sour taste imparting component in a variety of ‘conventional’ chocolate compositions and chocolate confectionery products produces unique taste and flavor profiles. In accordance with particularly preferred embodiments the invention, the component imparting sour taste is a particulate composition comprising non-neutralized or partially neutralized organic acid, optionally surrounded by a coating comprising partially neutralized polycarboxylic acid. The sour taste imparting component of the present invention was found to produce particularly beneficial results in chocolate confectionery products wherein a fruit-flavoured component or composition is present. Also provided by the invention are processes of producing chocolate compositions comprising certain components capable of imparting a sour taste attribute. The present invention also provides the use of organic acids for imparting sour taste in a chocolate composition.

### CROSS-REFERENCE TO RELATED PATENT APPLICATIONS

This application is a continuation of International Application No. PCT/EP2018/063211 filed on May 18, 2018, which claims priority to European Application No. 17172255.6, filed on May 22, 2017. The specification, drawings, claims and abstract of the prior applications are incorporated herein by reference in their entireties.

### FIELD OF THE INVENTION

The present invention concerns new chocolate compositions with unique sensory attributes. More in particular, the present invention concerns chocolate compositions comprising certain components capable of imparting a sour taste attribute. In addition, the invention provides a process of producing chocolate compositions comprising certain components capable of imparting a sour taste attribute as well as the use of said components for imparting sour taste in a chocolate composition.

### BACKGROUND OF THE INVENTION

There are various common chocolate compositions, such as dark chocolate, milk chocolate and white chocolate, which generally have in common that they are produced from (at least) one of the main materials obtained in conventional cacao bean processing, notably cacao solids and cacao butter. Generally stated, dark chocolate mainly comprises cacao solids, cacao butter and sugar; milk chocolate mainly comprises cacao solids, cacao butter, milk solids and sugar; and white chocolate typically contains cocoa butter, sugar, and milk as the main ingredients (and no cocoa solids). Many varieties of the basic types of chocolate have been developed, e.g. by blending other taste and/or flavor imparting substances into the chocolate compositions.

Besides the basic chocolate making, i.e. the process of converting cacao and other basic ingredients into a chocolate composition, the crafting of pieces of chocolate confectionery constitutes an art per se. Chocolate compositions are combined with other edible compositions with the aim of producing unique organoleptic properties. Also, a lot of attention is often given to (visual) esthetics of the products. Chocolate confectionery can be produced in large quantities industrially, but chocolate confectionery making is also still considered a true form of art (performed by ‘chocolatiers’).

CN 105 076 623 describes chocolate products comprising cocoa liquor 40-45%, xylitol 15-20%, skimmed milk powder 10-15%, Spirulina 6-8%, rice 20-25%, potato starch, 4-6%, glycyrrhizin 0.03-0.1%, glycine 0.03-0.1%, citrate 0.1-0.3%, phospholipids 0.1-0.5%. These chocolate products are prepared by a process in which potato starch and citric acid are combined with water and boiled before being combined with cooked rice, skimmed milk powder and sugar and being boiled to reduce moisture content to 6-8%. The resulting composition is cooled in a mould to produce an ellipsoid having a major axis length of 1-1.2 cm and a short axis length of 0.6-0.8 cm. These ellipsoids are coated with a molten cocoa mixture comprising cocoa liquor, xylitol, Spirulina, glycyrrhizin, glycine and phospholipids.

CN 105 076 624 describes confectionery products comprising cocoa liquor 25-30%, cocoa butter 10-15%, hydroxyl isomaltulose 15-20%, vegetables 30-40%, skimmed milk power 10-15%, sucralose 0.03-0.1%, phosphatide 0.1-0.5%, citric acid 1-3% and salt 5-8% by weight. These confectionery products are prepared by a process comprising spraying of vegetable pieces with citric acid solution, followed by freeze drying. Next, the freeze dried vegetable pieces are mixed with a molten chocolate mass containing cocoa liquor, cocoa butter, hydroxyl isomaltulose, skimmed milk power, sucralose, phosphatide and salt, followed by moulding.

WO 2008/006878 describes a food-grade particle comprising a core-coating configuration wherein the coating comprises at least one layer, each of which layers being made of a composition comprising at least 50 wt % of a partially neutralized polycarboxylic acid, wherein said partially neutralized polycarboxylic acid comprises at least one carboxylic group in the acid form and at least one carboxylic group in the salt form and wherein the core comprises at least one food-grade acid or a salt thereof.

There is a continuous desire to develop new and unique variations of the standard types of chocolate compositions, e.g. by finding new ingredients that complement and/or enhance typical chocolate taste and/or flavor notes in unique ways. Apart from the challenge to find and/or develop such ingredients per se, additional challenges can arise with a view to the compatibility of such new ingredients with the typical chocolate making processes, which will involve (amongst other things) exposure to moist and heat.

The present invention, generally stated, relates to these particular challenges and objectives.

### SUMMARY OF THE INVENTION

To this end, the present invention provides chocolate compositions comprising a component imparting sour taste.

As demonstrated in the examples incorporated herein, the inclusion of a sour taste imparting component in a variety of ‘conventional’ chocolate compositions (dark chocolate, milk chocolate and white chocolate) and chocolate confectionery products produced unique taste and flavor profiles that were highly appreciated by a professional test panel.

Particularly advantageous results were accomplished with the inclusion of a particulate composition comprising a non-neutralized or partially neutralized organic acid.

Also provided by the invention are processes of producing chocolate compositions comprising certain components capable of imparting a sour taste attribute. Without wishing to be bound by any particular theory, the present invention provides effective solutions for the problems that may typically arise in the handling of particulate organic acid based compositions under the conditions typically associated with chocolate processing.

The present invention also provides the use of organic acids for imparting sour taste in a chocolate composition.

### DETAILED DESCRIPTION OF THE INVENTION

A first aspect of the invention relates to a chocolate composition selected from dark chocolate, milk chocolate and white chocolate, said chocolate composition comprising a sour taste imparting component, wherein the sour taste imparting component comprises a plurality of discrete particles comprising at least 10 wt. % of a partially-neutralized or non-neutralized food-grade organic acid selected from the group consisting of lactic acid, malic acid, citric acid, succinic acid, propionic acid, maleic acid, tartaric acid, adipic acid, fumaric acid and mixtures thereof, said particles having a volume weighted mean diameter of at least 100 μm, as determined using laser diffraction technique.

In a preferred embodiment of the invention the sour taste imparting component is selected from the group consisting of lactic acid, malic acid, citric acid, tartaric acid and mixtures thereof. In one particularly preferred embodiment of the invention the organic acid is lactic acid. In another particularly preferred embodiment of the invention, the organic acid is malic acid.

In one embodiment of the invention, the sour taste imparting component is an organic acid having a degree of neutralization of less than 50%, less than 40%, less than 30%, less than 20%, less than 10%, less than 5%, less than 2.5% or less than 1%. In the context of this invention the degree of neutralization of the organic acid, as used herein, is a parameter expressing the amount of carboxylic groups present in the salt form relative to the total number of carboxyl groups within the sour taste imparting component, which can be equated as follows: (—COOM groups)/(sum of —COOM groups and —COOH groups)(*100 percent), where the —COOM groups represent a salt formed between an organic acid carboxyl group and a cation, for example a monovalent metal cation. In preferred embodiments of the invention, the sour taste imparting component comprise or consist of an organic acid containing at least 25 wt. %, at least 50 wt. %, at least 60 wt. %, at least 70 wt. %, at least 80 wt. %, at least 85 wt. %, at least 90 wt. %, at least 95 wt. %, e.g. at least 99 wt. %, of free acid.

According to an embodiment of the invention, the particle contains salts of malate ions and monovalent metal cations, preferably sodium and/or potassium ions, most preferably sodium ions, wherein the molar ratio of malate ions to monovalent metal cations 1/0.5 to 1/2, more preferably 1/0.75 to 1/1.5, more preferably 1/0.85 to 1/1.25, most preferably 1/0.9 to 1/1.1, e.g. approximately 1/1.

According to a particularly preferred embodiment at least 50 mol. %, more preferably at least 80 mol. %, more preferably at least 90 mol. %, and most preferably at least 95 mol. % of the cations contained in the particle are selected from the group consisting of sodium, potassium and combinations thereof, sodium being the most preferred.

The sour taste imparting component, will typically be present in an amount of at least 0.1 wt. %, based on the total weight of the chocolate composition, more preferably at least 0.2 wt. %, most preferably at least 0.4 wt. %.

In accordance with the invention, the particles can have varying configurations. In one embodiment of the invention, the particles entirely consist of the non- or partially-neutralized organic acid as defined herein before. In other embodiments, the particles comprise a core surrounded by the non- or partially-neutralized organic acid as defined herein before. For example, depending on how the particles are produced, they may comprise a seed material surrounded by the organic acid. In other embodiments of the invention, the particles comprises a carrier material in combination with the non- or partially-neutralized organic acid. Furthermore, as will be explained herein elsewhere, the particles may comprises one or more additional layers of a coating material.

In a preferred embodiment of the invention the particles comprises at least 25 wt. %, at least 40 wt. %, at least 50 wt. %, at least 60 wt. %, at least 70 wt. %, at least 80 wt. %, at least 85 wt. %, at least 90 wt. %, at least 95 wt. %, at least 97 wt. %, at least 98 wt. %, or least 99 wt. % of the organic acid, in non-neutralized or partially neutralized form, based on the total weight of the particle.

The particles of the invention thus may comprise other materials than the organic acid. In certain embodiments, the particles may comprise one or more other functional ingredients, such as e.g. flavoring agents, preservatives, anti-microbial, and/or food fortification agents. In some embodiments of the invention, the particles contain one or more excipients, such as a carrier material or a seed-particle.

The particles of the present invention can be amorphous or crystalline. The particle thus may have various forms ranging from a round shaped particle to a randomly shaped particle. The particles of the present invention may have various shapes and sizes, typically depending on how it is produced. Suitable technologies to produce the cores include extrusion, spray-drying, spray-coating, agglomeration, etc. The shape of the core particles may typically be spherical, substantially spherical, plate-like, rod-like, oblong, etc. to substantially random-shaped. Particles may consist of agglomerates of several smaller particles.

The particles typically have a size characterized by a volume weighted mean diameter of 100-500 μm. Even more preferably, the volume weighted mean diameter of the cores is within the range of 200-400 μm, most preferably within the range of 250-350 μm. These and other characteristics of particle size distribution can for instance be determined using laser diffraction technique, e.g. using Mastersizer 2000, Malvern Instruments, in manners known by those of average skill.

The particles of this invention may additionally comprise a coating. As is understood by those skilled in the art, this merely implies that the particles have at least two distinguishable portions, made up of distinct material compositions, wherein one of said portions, i.e. the coating, is present at the outer surface of the particle, while the other portion, i.e. the core particle functions as the substrate onto which the coating is applied. A coating does not necessarily cover the entire surface of a core particle. Coatings covering only part of the surface of the core can be designed in many ways, for instance by applying a coating to only a fraction of the surface of a core, by applying a coating having macroporosity, etc. Furthermore, it is to be understood that the materials of the coating and core particle may partly coalesce, so that there may not be a sharp border between these two parts. Nonetheless, in such embodiments, it will still be possible to identify core and coating regions having the distinct compositions as defined herein.

In accordance with the invention, it was found that the partially- or non-neutralized organic acids that are contemplated herein as the sour taste imparting component may display hygroscopic behavior and may thus absorb water from the chocolate composition, which will negatively affect the quality and stability thereof and, additionally, will result in deterioration of the sour taste imparting particles itself. The present inventors have found that the application of the coating can mitigate these effects. Additionally, it has been established that the application of fat based coatings is less favorable as such fats may be taken up by the chocolate matrix.

In preferred embodiments of the invention, the coating comprises a partially or completely neutralized food-grade organic acid. In accordance with the invention, the food-grade organic acid is typically selected from the group consisting of lactic acid, malic acid, citric acid, succinic acid, propionic acid, maleic acid, tartaric acid, adipic acid, fumaric acid and mixtures thereof. In a preferred embodiment of the invention the coating comprises a partially or completely neutralized food-grade polycarboxylic acid, more preferably a polycarboxylic acid selected from the group consisting of f malic acid, citric acid, succinic acid, maleic acid, fumaric acid, adipic acid, tartaric acid, and/or mixtures hereof. In a particularly preferred embodiment of the invention, the polycarboxylic acid is malic acid, tartaric acid, citric acid or a mixture thereof. In one particularly preferred embodiment of the invention the polycarboxylic acid is malic acid. In another particularly preferred embodiment of the invention, the polycarboxylic acid is tartaric acid. Malic acid is most preferred, optionally in combination citric acid or tartaric acid.

In other preferred embodiments of the invention, the core comprises a partially or completely neutralized food-grade organic acid. In accordance with the invention, the food-grade organic acid is typically selected from the group consisting of lactic acid, malic acid, citric acid, succinic acid, propionic acid, maleic acid, tartaric acid, adipic acid, fumaric acid and mixtures thereof. In a preferred embodiment of the invention the core comprises partially or completely neutralized lactic acid, malic acid, citric acid, propionic acid, maleic acid, tartaric acid, and/or mixtures hereof. In a particularly preferred embodiment of the invention, the carboxylic acid is lactic acid.

According to a particularly preferred embodiment at least 50 mol. %, more preferably at least 80 mol. %, more preferably at least 90 mol. %, and most preferably at least 95 mol. % of the cations contained in the core material are selected from the group consisting of sodium, potassium, calcium and combinations thereof, calcium being the most preferred.

As will be understood from the foregoing, in accordance with the invention, the core material and coating material are typically distinct. In some embodiments of the invention, the core material and coating material comprise or consist of distinct organic acids or mixtures of organic acids. In other embodiments of the invention, the core and coating comprise or consist of the same organic acid or mixture of organic acids but differ in the degree of neutralization. Using such configurations it is possible to design particles that have specific taste profiles, such as a gradual increase in sour taste or, conversely, by producing an instantaneous sour taste peak. At the same time, coatings may be designed such as to protect the particle from the environment, during processing and storing of the chocolate composition, or, conversely, by protecting the chocolate composition from the organic acid.

In a particularly preferred embodiment of the invention, the particles are characterized by a weight ratio of coating material to core particle within the range of 10/90-60/40, more preferably within the range of 20/80-50/50, most preferably within the range of 25/75-40/60. In certain embodiments of the invention, the coating makes up at least 20 wt. % of the particle, based on the total weight thereof, and preferably about 40 to 80 wt. %, more preferably about 50-70 wt. % and most preferably 65-70 wt. %.

In preferred embodiments of the invention, the coating material contains an organic acid with a degree of neutralization of more than 25%, more than 35%, more than 40%, more than 45% or more than 50%. In an embodiment said degree of neutralization is between 30 and 70%, more preferably between 40 and 60%, more preferably between 45 and 55%, more preferably between 47 and 53%, more preferably between 48 and 52%, e.g. around 50%. In preferred embodiments of the invention, the coating material comprises at least 50 wt. %, at least 55 wt. %, at least 60 wt. %, at least 65 wt. %, at least 70 wt. %, at least 75 wt. %, at least 80 wt. %, at least 85 wt. %, at least 90 wt. % at least 95 wt. % or at least 99 wt. % of said organic acid. According to an embodiment of the invention, the coating material contains salts of malate ions and monovalent metal cations, preferably sodium and/or potassium ions, most preferably sodium ions, wherein the molar ratio of malate ions to monovalent metal cations is 1/0.5 to 1/2, more preferably 1/0.75 to 1/1.5, more preferably 1/0.85 to 1/1.25, most preferably 1/0.9 to 1/1.1, e.g. approximately 1/1.

According to a particularly preferred embodiment at least 50 mol. %, more preferably at least 80 mol. %, more preferably at least 90 mol. %, and most preferably at least 95 mol. % of the cations contained in the coating material are selected from the group consisting of sodium, potassium and combinations thereof, sodium being the most preferred.

In other preferred embodiments of the invention, the coating material contains a non-neutralized organic acid. In preferred embodiments of the invention, the coating material comprises at least 50 wt. %, at least 55 wt. %, at least 60 wt. %, at least 65 wt. %, at least 70 wt. %, at least 75 wt. %, at least 80 wt. %, at least 85 wt. %, at least 90 wt. % at least 95 wt. % or at least 99 wt. % of said organic acid. According to an embodiment of the invention, the coating material contains lactic acid, malic acid, citric acid, propionic acid, maleic acid, tartaric acid, and/or mixtures hereof, most preferably lactic acid or tartaric acid.

As noted before, the particles, in certain embodiments of the invention, may comprise a coating layer comprising partially or completely neutralized polycarboxylic acid. The expression “partially neutralized polycarboxylic acid” according to the invention means an acid with more than one carboxylate group, at least one of which exists in the salt form. Example are mono-sodium dihydrogen citrate having one neutralized carboxylic group and two carboxylic groups in the acid form, and di-sodium hydrogen citrate comprising two neutralized carboxylic groups and one acid group.

The partially or completely neutralized polycarboxylic acid may have several functionalities: by virtue of the presence of an acid group it may provide some sourness on the one hand and on the other hand it confers stability to the particle. Partially neutralized malic acid was found to have very good coating properties. The result is a food-grade particle comprising a core and a coating wherein the coating is multifunctional: the coating material to some extent imparts sour taste and further acts as a coating providing increased stability and shelf life. A coating material comprising mono-sodium or mono-potassium hydrogen malate provides both a very stable coating and imparts some acidic taste. It is well-known that most food-grade acids may be instable because of their hygroscopicity. Acid particles coated with a partially or completely neutralized polycarboxylic acid have been found to be very stable resulting in an extended shelf life of the coated acid particles, per se as well as in the chocolate compositions in which they are to be incorporated, without significant changes in taste, texture, and/or appearance of the coated particles. Further, said coated acid particles have an instant and relatively easy mechanism for acid release by means of contact with moisture such as e.g. saliva, optionally accompanied with a change in pH. The coated acid according to the invention releases its acid in a few seconds due to the instant dissolving of the partially neutralized polycarboxylic acid in the coating (in contrast to the dissolving of a coating layer comprising fat which takes significantly longer as known in the art). The acid in the core and the acid that is used as in the coating are not necessarily the same. By combining acids with a different acid taste profile, a particle can be made with an acid taste sensation that is changing during consumption. For instance, coated particles can be designed providing a prolonged and undiluted acid taste sensation due to firstly the partially acidic coating layer that dissolves and secondly the release of the acid in the acid-comprising core. This makes the coated acid particles particularly suitable for the application in chocolate compositions.

In one embodiment of the invention, the polycarboxylic acid has a degree of neutralization of more than 33%, more than 40%, more than 50% or more than 66%. In one embodiment of the invention the degree of neutralization is 100% or less, e.g. less than 90%, less than 80% or less than 75%.

According to an embodiment of the invention, the coating comprises (partial) salts of the polycarboxylic acid, wherein the cations are monovalent metal cations, preferably sodium and/or potassium ions, most preferably sodium ions, wherein the molar ratio of polycarboxylic acid anions to monovalent metal cations is 1/0.5 to 1/2, more preferably 1/0.75 to 1/1.5, more preferably 1/0.85 to 1/1.25, most preferably 1/0.9 to 1/1.1, e.g. approximately 1/1.

According to a particularly preferred embodiment at least 50 mol. %, more preferably at least 80 mol. %, more preferably at least 90 mol. %, and most preferably at least 95 mol. % of the cations contained in the particle are selected from the group consisting of sodium, potassium and combinations thereof, sodium being the most preferred.

In preferred embodiments of the invention, the coating material comprises at least 50 wt. %, at least 55 wt. %, at least 60 wt. %, at least 65 wt. %, at least 70 wt. %, at least 75 wt. %, at least 80 wt. %, at least 85 wt. %, at least 90 wt. % or at least 95 wt. % of the partially or completely neutralized polycarboxylic acid.

A coating comprising mono-sodium or mono-potassium hydrogen malate, mono-sodium or mono-potassium hydrogen tartrate, mono-sodium or mono-potassium dihydrogen citrate, or di-sodium or di-potassium hydrogen citrate are found to provide both a very stable coating and a very nice acidic taste sensation; most preferred is a coating comprising sodium or potassium hydrogen malate. Hence, in preferred embodiments of the invention, the coating material comprises at least 50 wt. %, at least 55 wt. %, at least 60 wt. %, at least 65 wt. %, at least 70 wt. %, at least 75 wt. %, at least 80 wt. %, at least 85 wt. %, at least 90 wt. % or at least 95 wt. % of sodium hydrogen malate, potassium hydrogen malate or combinations thereof, most preferably sodium hydrogen malate.

The coating or encapsulation layer involves a layer or shell around the core wherein the layer can have a varying thickness. The coating layer further may consist of several layers. The encapsulation or coating layer may be entirely or partially closed depending on the application for which it is used.

The coated particles of the inventions may have any shape, ranging from (substantially) spherical, plate-like, rod-like, oblong, etc. to substantially random-shaped. In a preferred embodiment of the invention, the particles are spherical or substantially spherical in shape. The coated particles typically have a size characterized by a volume weighted mean diameter of 200-600 μm, as determined using laser diffraction technique, using e.g. Mastersizer 2000, Malvern Instruments. Even more preferably, the volume weighted mean diameter of the particles is within the range of 250-550 μm, most preferably within the range of 300-500 μm. In a particularly preferred embodiment of the invention, the particles are spherical or substantially spherical in shape and have a volume weighted mean diameter of 200-600 μm, more preferably of 250-550 μm, most preferably of 300-500 μm.

The particles coated with a partially or completely neutralized polycarboxylic acid as described herein have varying and long-lasting acidic taste sensation and have proven to be very suitable for application in chocolate compositions and chocolate confectionery products. All combinations of above-mentioned food-grade acids as core and/or as coating are possible.

A particularly preferred embodiment of the invention concerns lactic acid particles coated with mono-sodium or mono-potassium hydrogen malate.

Particles with a lactic acid-comprising core and a coating comprising mono-sodium or mono-potassium hydrogen malate were found to have a significantly increased shelf life with respect to taste, appearance and texture of the coated particles.

A further example of coated particles that are particularly suited for the purposes of the invention are particles comprising a salt of lactic acid, as e.g. sodium lactate or potassium lactate, or a mixture of lactic acid and a salt thereof in combination with a coating composition comprising mono-sodium or mono-potassium hydrogen malate.

A further example and preferred embodiment of the present invention comprises particles comprising a coating of sodium or potassium hydrogen malate and a core comprising a mixture of malic acid and sodium or potassium hydrogen malate. The core may comprise up to about 60 wt. % malic acid. Preferably, the core comprises from 5 to 55 wt. % malic acid and 90 to 45 wt. % sodium or potassium hydrogen malate; even more preferably the core comprises 30 to 54 wt. % malic acid and 70 to 46 wt. % sodium or potassium hydrogen malate. It was found that these particles were most enjoyed because of the immediate and long-lasting sour taste sensation. The particles further appeared to be very stable in appearance and taste and showed an extended shelf-life.

The coated particles used in accordance with the present invention can suitably be produced by a method wherein a core particle containing partially or non-neutralized organic acid as defined herein is coated by bringing it in contact with a solution comprising partially or completely neutralized organic, preferably polycarboxylic, acid as defined herein. Said contacting can take place via e.g. spraying or sprinkling a solution comprising the partially or completely neutralized organic, preferably polycarboxylic, acid on the core particles until a partially or completely closing coating layer of a desired thickness is obtained. The core particles may also be submerged or dipped in a solution comprising the partially or completely neutralized organic, preferably polycarboxylic, acid, after which the particles are separated from said solution. The process may be performed batch-wise or continuous. It may take place in a fluid bed dryer, spray dryer, spray granulator, or similar piece of equipment well-known to the person skilled in the art, wherein the core particles are fluidized or by other means mixed while being contacted e.g. sprayed with or dipped in the solution comprising the partially or completely neutralized organic, preferably polycarboxylic, acid. The coated particles are allowed to dry following the contacting, or alternatively may be dried actively, simultaneously, or subsequently by any drying means well-known to the person skilled in the art. The particles may optionally be again subjected to a spraying or dipping process in order to obtain several coating layers. In embodiments of the invention, the sour taste imparting component is a particle or particulate composition obtainable by this process.

Further examples of particulate sour taste imparting compositions that can be used advantageously in accordance with the invention have been described in the prior art, in particular in WO2008/006878. Furthermore, particulate sour taste imparting compositions that can be used advantageously in accordance with the invention are available commercially, such as lactic acid powders (PURAC® Powder 55 and PURAC® Powder 60) and malic acid powder (PURAC® Powder MA) available from Corbion.

As will be evident from the foregoing, particularly preferred embodiments of the invention concern chocolate compositions comprising a sour taste imparting component, wherein the sour taste imparting component comprises a plurality of discrete particles having a core-coating configuration, wherein the core comprises a food-grade organic acid and the coating comprises a partially or completely neutralized food-grade organic acid.

Further particularly preferred embodiments of the invention concern chocolate compositions comprising a sour taste imparting component, wherein the sour taste imparting component comprises a plurality of discrete particles having a core-coating configuration, wherein the core comprises a food-grade organic acid and the coating comprises a partially neutralized polycarboxylic acid.

Further particularly preferred embodiments of the invention concern chocolate compositions comprising a sour taste imparting component, wherein the sour taste imparting component comprises a plurality of discrete particles having a core-coating configuration, wherein the core particle comprises malic acid having a degree of neutralization of less than 30% and the coating comprises a malic acid having a degree of neutralization of more than 40%.

The sour taste imparting component, will typically be present in amounts of at least 0.1 wt. %, based on the total weight of the product, more preferably at least 0.2 wt. %, most preferably at least 0.4 wt. %. Said amount typically does not exceed 50 wt. %, based on the total weight of the product, more preferably it does not exceed 40 wt. %, most preferably it does not exceed 30 wt. %.

A chocolate composition according to the present invention is a composition that comprises cocoa solids. In a preferred embodiment of the present invention, chocolate compositions comprise at least 2 wt. % total dry cocoa solids up to 100%, more preferably in an amount of 15-90%, more preferably in an amount of 20-80% cocoa solids, more preferably in an amount of 25-70%, more preferably in an amount of 30-60%, more preferably in an amount of 30-60% cocoa solids, more preferably in an amount of 35-50% cocoa solids, and more preferably in an amount of 40-45% cocoa solids.

The chocolate composition may further comprise sugar or other sweetening matter including artificial sweeteners, fat and/or protein.

Preferably at least 10 wt. % of sweetening matter is present in the chocolate composition. Sweetening matter may be sugar, such as simple sugars (monosaccharides) such as glucose, fructose, and galactose, or disaccharides such as sucrose, maltose and lactose. Sweetening matter may also include sugar substitutes such as stevia, steviol glycosides, aspartame, sucralose, acesulfame potassium, aspartame-acesulfame salt, saccharin, sorbitol, xylitol, cyclamate, brazzein, curculin, erythritol, glycyrrhizin, glycerol, hydrogenated starch hydrolysates, isomalt, lactitol, mogroside, mabinlin, maltitol, mannitol, miraculin, monatin, monelin, osladin, pentadin, tagatose, thaumatin, alitame, dulcin, glucin, neohesperidin dihydrochalcone, neotame, advantame, P-4000 and/or combinations thereof. Also envisioned are combinations of sugar and sugar substitutes. In a preferred embodiment, at least 12 wt. % sweetening matter is present in the chocolate composition, more preferably at least 15 wt. %, more preferably at least 20 wt. %, more preferably at least 22 wt. %, more preferably at least 25 wt. %, more preferably at least 30 wt. %, more preferably at least 35 wt. %, more preferably at least 40 wt. %, more preferably at least 45 wt. %, more preferably at least 50 wt. %, more preferably ate least 55 wt. %, more preferably at least 60 wt. %. In a preferred embodiment of the present invention and embodiments thereof, the sweetening matter is sugar, and/or a mix of sugar with sugar substitutes. It is to be understood that some sweetening materials have a high sweetness index, while others have a lower sweetness index. A skilled person will understand that a sweetening material with high sweetness index may be used in a lower amount than sweetening materials with lower sweetness index. In another preferred embodiment, the chocolate composition according to the invention and/or embodiments thereof comprises sugar and/or sweetening matter preferably in an amount of 20 to 90 wt. %, more preferably in an amount of 30 to 80 wt. %, more preferably in an amount of 35 to 70 wt. % and more preferably in an amount of 40 to 60 wt. %, and more preferably in an amount of 45-45 wt. % based on total weight of the chocolate.

Chocolate compositions may comprise milk or milk derived ingredients, such as milk powder, preferably in an amount of 0-40 wt. %. In a preferred embodiment chocolate compositions may comprise sugar or other sweetening matters and/or low calorie sugar replacers, preferably in an amount of 0-80 wt. %, more preferably in an amount of 10-70%, more preferably in an amount of 20-60%, more preferably in an amount of 25-55%, more preferably in an amount of 30-50%, more preferably in an amount of 35-45%.

In a preferred embodiment, the chocolate composition, comprises at least 43 wt. % total dry cocoa solids, and preferably at least 26 wt. % cocoa butter. In another preferred embodiment the chocolate composition comprises at least 30 wt. % total dry cocoa solids and preferably comprises at least 18 wt. % dry milk solids, preferably including not less than 4 wt. % milk fat.

White chocolate preferably comprises, cocoa butter, milk or milk products and sugars and preferably comprises at least 20 wt. % cocoa butter, preferably at least 14 wt. % dry milk solids and preferably at least 3.5% is milk fat and/or milk fat fractions.

The chocolate composition according to the invention and/or embodiments thereof may comprise a fat phase in an amount of 5 to 50 wt. %, more preferably in an amount of 10 to 40 wt. %, more preferably in an amount of 15 to 35 wt. % and most preferably in an amount of 20 to 30 wt. %.

Preferably the majority of the fat phase of the chocolate composition or chocolate coating of the present invention and/or embodiments thereof comprises of cocoa butter. In a preferred embodiment the chocolate composition according to the invention and/or embodiments thereof comprises cocoa butter preferably in an amount of 5-40 wt. %, 10 to 35 wt. %, most preferably in an amount of 20 to 35 wt. % on total weight of the chocolate composition. The chocolate composition or chocolate coating according to present invention and/or embodiments thereof may comprise up to 5 wt. % of milk fat fractions, preferably 0.5-5 wt. % milk fat fraction, more preferably 1-4 wt. % milk fat fraction, more preferably 1.5-3.5 wt. % most preferably 2-3 wt. % milk fat fraction based on total weight of the chocolate. On the basis of the fat phase, the chocolate composition or chocolate coating comprises up to 18 wt. % milk fat fraction, preferably from 1 to 18 wt. %, more preferably from 3 to 15 wt. % milk fat fraction, more preferably from 5 to 2 wt. % milk fat fraction and most preferably from 7 to 10 wt. % milk fat fraction based on the fat phase of the chocolate composition. In a preferred embodiment the fat phase of the chocolate composition of the present invention and/or embodiments thereof contains only milk fat fraction and cocoa butter. Preferably, the amount of cocoa butter in the fat phase is at least 20 wt. %, more preferably at least 50 wt. %, more preferably at least 60 wt. %, more preferably at least 70 wt. %, more preferably at least 80 wt. %, more preferably at least 82 wt. %, more preferably at least 86 wt. %, more preferably at least 90 wt. %, more preferably at least 93 wt. %, more preferably at least 95 wt. % more preferably at least 97 wt. % and most preferably at least 99 wt. % on fat phase. However in an another embodiment the chocolate composition of the invention and embodiments thereof the fat phase may comprise other fats than milk fat fraction and cocoa butter.

In another preferred embodiment the chocolate composition according to the invention and/or embodiments thereof comprises milk or milk powder, preferably in an amount of 0 to 50 wt. %, preferably 1 to 40 wt. %, more preferably 2 to 35 wt. %, more preferably 3-30 wt. %, more preferably 5-25 wt. % and more preferably 10-22 wt. %, and more preferably from 15-20 wt. %.

In another preferred embodiment the chocolate composition according to the invention and/or embodiments thereof comprises dry fat free cocoa solids preferably in an amount of 2.5 to 45 wt. %, more preferably in an amount of 5 to 40 wt. %, more preferably in an amount of 10-35 wt. %, more preferably in an amount of 15 to 30 wt. %, more preferably in an amount of 20 to 25 wt. %. Dry fat free cocoa solids are the solid fraction of chocolate mass or liquor which remains when the cocoa butter has been removed.

In another preferred embodiment the chocolate composition according to the invention and/or embodiments thereof comprises other ingredients selected from the group comprising emulsifiers such as lecithin from soy, sunflower, or rapeseed, AMP, mono- and diglycerides and their lactic acid esters and citric acid ester (citrem), PG PR, sucrose esters of fatty acids, STS, aromas or flavors such as vanilla, vanillin, herbs, and/or other

The chocolate compositions will typically be in the form of a solid shaped article, such as in the form of conventional chocolate blocks or in the form of decoratively shaped articles, such as chocolate figures, chocolate confectionery, pralines, Belgian chocolates, etc. Liquid or semi-liquid chocolate compositions are also envisaged.

In accordance with the invention it has been found that the incorporation of the sour taste imparting component is particularly beneficial in products containing, besides a chocolate composition, other edible or food-grade compositions. For ease of reference, such products will be referred to herein as ‘chocolate confectionery’, as distinguished from the base chocolate compositions as defined herein before. Such edible or food grade compositions typically are liquid, solid or semi-solid and include chocolate confectionery, chocolate bars, pralines, Belgian chocolates, etc.

Hence, particularly preferred embodiments of the invention concern chocolate confectionery product comprising a chocolate composition a second liquid, semi-solid or solid food grade composition and a sour taste imparting component as defined herein; said confectionery product typically comprising discrete/distinguishable portions of the chocolate composition and the second food-grade composition.

Certain embodiments of the invention concern chocolate confectionery product comprising a chocolate composition as defined herein in combination with a second liquid, semi-solid or solid food grade composition, said confectionery product typically comprising discrete/distinguishable portions of the chocolate composition and the second food-grade composition. Also encompassed by the invention is chocolate confectionery comprising a chocolate composition in combination with a second liquid, semi-solid or solid food grade composition comprising a sour taste imparting component as defined herein, said confectionery product typically comprising discrete/distinguishable portions of the chocolate composition and the second food-grade composition. Also encompassed by the invention is chocolate confectionery comprising a chocolate composition a second liquid, semi-solid or solid food grade composition and a sour taste imparting component, wherein the latter is not blended within and/or throughout the chocolate composition or said second liquid, semi-solid or solid food grade composition, but e.g. applied only on the surface of the chocolate confectionery product or only on part of the surface of the chocolate confectionery product.

The second liquid, semi-solid or solid food grade composition can be any type of composition that is conventionally applied in chocolate confectionery products as defined herein and/or that can suitably be combined with such chocolate confectionery products to produce a desired organoleptic and/or esthetic effect. Typically, said second liquid, semi-solid or solid food grade composition can be, e.g., a paste, syrup, puree, jelly, praline, ganache, confiture, etc.

Edible composition that may advantageously be combined with the present chocolate compositions to produce unique chocolate confectionery include processed fruit pieces, such as dried or candied fruit pieces; compositions containing fruit extracts or (artificial) fruit flavours, such as fruit flavoured pastes, purees, jellies, confiture or syrup; nuts or pieces of nut, nut-based or nut-flavoured compositions, marzipan, caramel, dairy-based cream or spread, praline, nougat, etc.

Further particularly preferred embodiments of the invention concern chocolate confectionery product comprising a chocolate composition as defined herein in combination with a second liquid, semi-solid or solid food grade composition, wherein the second food grade composition is a fruit-flavored composition, preferably a composition comprising a fruit juice, fruit extract, fruit confiture, dried fruit and/or an artificial fruit flavor.

A second aspect of this invention, concerns a method of producing a chocolate composition, comprising the steps of:

a) providing a molten chocolate composition as described herein;
b) providing a quantity of a sour taste imparting component as defined herein;
c) blending said quantity of a sour taste imparting component through the molten chocolate composition; and
d) allowing the mass obtained in step c) to cool down and solidify

A further aspect of this invention, concerns a method of producing a chocolate confectionery product, comprising the steps of a) providing a chocolate composition comprising a sour taste imparting component as defined herein; b) providing a second liquid, semi-solid or solid food-grade composition as defined herein; and c) producing a shaped article comprising discrete/distinguishable portions of the chocolate composition and the second food-grade composition.

A further aspect of this invention, concerns a method of producing a chocolate confectionery product, comprising the steps of a) providing a chocolate composition; b) providing a second liquid, semi-solid or solid food-grade composition, comprising a sour taste imparting component that comprises a plurality of discrete particles comprising at least 10 wt. % of partially-neutralized or non-neutralized food-grade organic acid selected from lactic acid and malic acid, said particles having a volume weighted mean diameter of at least 100 μm, as determined using laser diffraction technique; and c) producing a shaped article comprising discrete/distinguishable portions of the chocolate composition and the second food-grade composition.

A further aspect of this invention, concerns a method of producing a chocolate confectionery product, comprising the steps of a) providing a chocolate composition; b) providing a second liquid, semi-solid or solid food-grade composition; c) providing a sour taste imparting component that comprises a plurality of discrete particles comprising at least 10 wt. % of partially-neutralized or non-neutralized food-grade organic acid selected from lactic acid and malic acid, said particles having a volume weighted mean diameter of at least 100 μm, as determined using laser diffraction technique; and d) producing a shaped article comprising discrete/distinguishable portions of the chocolate composition, the second food-grade composition and the sour taste imparting component.

A further aspect of this invention concerns chocolate compositions that are obtained and/or obtainable by the processes defined herein and to chocolate confectionery products that contain these chocolate compositions.

A further aspect of this invention, concerns the use of a sour taste imparting component as defined herein, for imparting sour taste attributes in chocolate compositions and/or chocolate confectionery, said use comprising blending a quantity of the sour taste imparting component through a molten chocolate composition selected from dark chocolate, milk chocolate and white chocolate, and allowing the mass so obtained to cool down and solidify.

Thus, the invention has been described by reference to certain embodiments discussed above. It will be recognized that these embodiments are susceptible to various modifications and alternative forms well known to those of skill in the art.

Many modifications in addition to those described above may be made to the structures and techniques described herein without departing from the spirit and scope of the invention. Accordingly, although specific embodiments have been described, these are examples only and are not limiting upon the scope of the invention.

Furthermore, for a proper understanding of this document and in its claims, it is to be understood that the verb “to comprise” and its conjugations is used in its non-limiting sense to mean that items following the word are included, but items not specifically mentioned are not excluded. In addition, reference to an element by the indefinite article “a” or “an” does not exclude the possibility that more than one of the element is present, unless the context clearly requires that there be one and only one of the elements. The indefinite article “a” or “an” thus usually means “at least one”.

All patent and literature references cited in the present specification are hereby incorporated by reference in their entirety.

The following examples are offered for illustrative purposes only, and are not intended to limit the scope of the present invention in any way.

### EXAMPLES

### Example 1: Orange Flavored Chocolate Composition Comprising Sour Taste Imparting Component

Orange flavored pure chocolate is produced, having the composition recited in the below table, by adding chocolate to the top of a double boiler and stirring until chocolate has fully melted. The sour taste imparting component (Purac Powder MA) and the orange flavor are added and the resulting mass is stirred well. The mass is poured into a chocolate mold and allowed to cool.

| Ingredient | Amount (%) |
|---|---|
| Purac Powder MA | 0.5 |
| Orange flavor (Firmenich) | 0.1 |
| Dark chocolate composition | to 100% |

### Example 2: Chocolate-Apricot Confectionery Product Comprising Sour Taste Imparting Component

Preformed chocolate spheres are filled with an apricot filling using the recipe recited in the table below.

The apricot filling is produced by first cooking the puree and sugar, followed by addition of sugar and pectin, while continuing to cook the mixture. The sour taste imparting component (Purac Powder 55) is added last. The cold filling is injected into the (preformed) chocolate spheres through a hole that is subsequently closed with tempered chocolate. Finally the filled chocolate is contacted with tempered chocolate and sprinkled with a combination of sugar, sour taste imparting component (Purac Powder MA) and gold powder.

| Ingredient | Amount (g) |
|---|---|
| Apricot puree | 500 |
| Castor melis (sugar) | 100 |
| Castor melis (sugar) | 800 |
| Pectin | 90 |
| Purac 55 | 23 |
| Castor melis (sugar) | 200 |
| Purac MA | 10 |
| Gold powder | |

### Example 3: Chocolate-Coconut Confectionery Product Comprising Sour Taste Imparting Component

White chocolate is melted (by tempering) and subsequently combined with the sour taste component (Purac Powder MA). The mass is poured into molds and sprinkled with a combination of the cocos, florentiner and sour taste imparting component (Purac Powder MA). The recipe is as follows.

| Ingredient | Amount (g) |
|---|---|
| White chocolate | 100 |
| Purac MA | 2 |
| Cocos | 10 |
| Florentiner | 12 |
| Purac MA | 2 |

### Example 4: Chocolate-Caramel-Sea Salt Confectionery Product Comprising Sour Taste Imparting Component

Caramel is prepared from sugar and whipped cream, by caramelizing the sugar and adding the cream, followed by cooking to 92° C. Caramel is cooled and subsequently combined with nougat, sea salt and the sour taste imparting component (Purac Powder MA). The mixture thus obtained is used as a filling for preformed chocolate spheres. The recipe is as follows.

| Ingredient | Amount (g) |
|---|---|
| Castor melis (sugar) | 200 |
| Whipped cream | 200 |
| Almond nougat | 90 |
| Sea salt | 6 |
| Purac MA | 6 |

### Example 5: Chocolate-Strawberry-Raspberry Confectionery Product Comprising Sour Taste Imparting Component

Preformed chocolate spheres are filled with strawberry/raspberry filling having the composition recited in the table below.

This filling is produced by first cooking the purees and sugar, followed by addition of sugar and pectin, while continuing to cook the mixture. The raspberry powder and sour taste imparting component (Purac Powder 55) are added last. The cold filling is injected into the (preformed) chocolate spheres through a hole that is subsequently closed with tempered chocolate. Finally the filled chocolate is contacted with tempered chocolate and sprinkled with a combination of sugar, sour taste imparting component (Purac Powder MA) and bronze powder. The recipe is as follows.

| Ingredient | Amount (g) |
|---|---|
| Strawberry puree | 200 |
| Raspberry puree | 300 |
| Castor melis (sugar) | 100 |
| Castor melis (sugar) | 800 |
| Pectin | 90 |
| Purac 55 | 19 |
| Raspberry powder | 70 |
| Castor melis (sugar) | 200 |
| Purac MA | 10 |
| Bronze powder | |

### Example 6: Chocolate-Marzipan Confectionery Product Comprising Sour Taste Imparting Component

Marzipan is processed into a 36×36 cm square. A fruit filling is produced having the composition recited in the below table and poured on top of the marzipan. After the cooling/resting (overnight) of the marzipan/filling piece, the top and bottom are covered with tempered chocolate and the square is cut into pieces. The pieces are dipped in tempered chocolate. The recipe is as follows.

| Ingredient | Amount (g) |
|---|---|
| Marzipan | 550 |
| Vanilla | 1 piece |
| Purac 60 | 6 |
| Strawberry puree | 350 |
| Raspberry puree | 400 |
| Castor melis (sugar) | 635 |
| Glucose DE38/40 | 40 |
| Castor melis (sugar) | 75 |
| Pectin | 18 |
| Purac 55 | 16 |

1. A chocolate composition selected from dark chocolate, milk chocolate and white chocolate, the chocolate composition comprising a sour taste imparting component comprising a plurality of discrete particles comprising at least 10 wt. % of a partially-neutralized or non-neutralized food-grade organic acid selected from the group consisting of lactic acid, malic acid, citric acid, succinic acid, propionic acid, maleic acid, tartaric acid, adipic acid, fumaric acid and mixtures thereof, and the particles having a volume weighted mean diameter of at least 100 μm, as determined using laser diffraction technique.

2. The chocolate composition according to claim 1, wherein the particles have a core-coating configuration, wherein the core comprises a food-grade organic acid and the coating comprises a partially or completely neutralized food-grade organic acid.

3. The chocolate composition according to claim 2, wherein the coating comprises a partially neutralized polycarboxylic acid.

4. The chocolate composition according to claim 1, wherein the core comprises malic acid having a degree of neutralization of less than 30% and the coating comprises a malic acid having a degree of neutralization of more than 40%.

5. The chocolate composition according to claim 4, wherein the coating and core are present in a weight ratio of coating to core within the range of 10/90-60/40.

6. The chocolate composition according to claim 1, wherein the particles have a mean particle diameter of 200-600 μm, as determined using laser diffraction technique.

7. The chocolate composition according to claim 6, wherein the mean particle diameter is determined using a Mastersizer 2000, Malvern Instruments.

8. The chocolate composition according to claim 1, wherein the sour taste imparting component is present in an amount of at least 0.1 wt. %, based on the total weight of the chocolate composition.

9. A chocolate confectionery product, comprising a chocolate composition according to claim 1 and a second liquid, semi-solid or solid food grade composition.

10. The chocolate confectionery product according to claim 9, wherein the second food grade composition is a fruit-flavored composition.

11. The chocolate confectionery product according to claim 9, wherein the second food grade composition is a fruit juice, fruit extract, fruit confiture, dried fruit and/or an artificial fruit flavor.

12. The chocolate confectionery product according to claim 9, wherein the second food grade composition is a selected from paste, syrup, puree, jelly, praline and confiture.

13. A method of producing a chocolate composition, comprising:
(a) blending a quantity of a sour taste imparting component as defined in claim 1 through a molten chocolate composition selected from dark chocolate, milk chocolate and white chocolate; and
(b) allowing the mass obtained in (a) to cool down and solidify.

14. A product obtained by the method according to claim 13.

15. A method of producing a chocolate confectionery product, comprising: producing a shaped article comprising discrete/distinguishable portions of a chocolate composition comprising a sour taste imparting component as defined in claim 1 and a second liquid, semi-solid or solid food-grade composition.

16. A product obtained by the method according to claim 15.

17. A method of producing a chocolate confectionery product, comprising: producing a shaped article comprising discrete/distinguishable portions of a chocolate composition and a second liquid, semi-solid or solid food-grade composition, comprising a sour taste imparting component that comprises a plurality of discrete particles comprising at least 10 wt. % of partially-neutralized or non-neutralized food-grade organic acid selected from lactic acid and malic acid, said particles having a volume weighted mean diameter of at least 100 μm, as determined using laser diffraction technique.

18. A product obtained by the method according to claim 17.

19. A method of producing a chocolate confectionery product, comprising: producing a shaped article comprising discrete/distinguishable portions of (i) a chocolate composition, (ii) a second liquid, semi-solid or solid food-grade composition, and (iii) a sour taste imparting component that comprises a plurality of discrete particles comprising at least 10 wt. % of partially-neutralized or non-neutralized food-grade organic acid selected from lactic acid and malic acid, said particles having a volume weighted mean diameter of at least 100 μm, as determined using laser diffraction technique.

20. A product obtained by the method according to claim 19.
